(19) United States
(12) Patent Application Publication
(10) Pub. No.: US 2017/0337932 A1
(43) Pub. Date: Nov. 23, 2017

(54) BEAM SELECTION FOR NOISE SUPPRESSION BASED ON SEPARATION

(71) Applicant: Apple Inc., Cupertino, CA (US)

(72) Inventors: Vasu Iyengar, Pleasanton, CA (US); Ashrith Deshpande, San Jose, CA (US); Aram M. Lindahl, Menlo Park, CA (US)

(21) Appl. No.: 15/159,698

(22) Filed: May 19, 2016

(51) Int. Cl. G10L 21/0208; G10L 25/78

(52) U.S. Cl. CPC G10L 21/0208; G10L 25/78

(57) ABSTRACT

An audio system has a housing in which are integrated a number of microphones. A programmed processor accesses the microphone signals and produces a number of acoustic pick up beams. A number of separation values are computed, each being a measure of the difference between strength of a respective beam and strength of a noise reference input signal. One of the beams is selected whose separation value is the largest, and the selected beam is applied to a first input of a two-channel noise suppression process, while the noise reference input signal is applied to the second input of the noise suppression process. Other embodiments are also described and claimed.

### FIELD

An embodiment of the invention relates to digital signal processing techniques for reducing audible noise from an audio signal that contains voice or speech that is being picked up by a mobile phone. Other embodiments are also described.

### BACKGROUND

Mobile phones can be used in acoustically different ambient environments, where the users voice (speech) that is picked up during a phone call or during a recording session is usually mixed with a variety of types and levels of ambient sound (including the voice of another talker.) This undesirable ambient sound (also referred to as noise here) interferes with speech intelligibility at the far-end of a phone call, and can lead to significant voice distortion particularly after having been processed by voice coders in a cellular communication network. For at least this reason, it is typically necessary to apply a high quality, digital Noise Suppression (NS) process to the mixture of speech and noise contained in an uplink audio signal, before passing the signal to a cell voice coder in a baseband communications chip of the mobile phone. Consider the handset mode of operation (against the ear) in a current mobile phone. Audio signals from two microphones, one at the top of the handset housing closer to the user's ear and another at the bottom close to the user's mouth, are used by a two-microphone NS process that is running in the phone. A conventional approach may be to compute signal to noise ratio (SNR) for each microphone signal by itself, by first predicting a stationary noise spectrum for the microphone signal and then computing the ratio of the microphone signal to the predicted stationary noise to find the SNR. The microphone signal having the largest SNR is then selected to be the voice dominant input of the two microphone NS process.

### SUMMARY

It has been recognized that even a 2-microphone NS process does not always work well in the presence of background noise that has transients (including a competing talker). Earlier study has revealed that noise estimation, which is a computation or estimate of the noise by itself, plays a key role when trying to remove noise components from a microphone signal without distorting the speech components therein. For greater accuracy, a two microphone noise estimation process needs i) the existence of sound pressure level difference between the microphones that is due to the local voice (the near end user's voice), and ii) little or no sound pressure difference that is due to far end noises (sound from noise sources that are far away from both microphones such that there is essentially no sound pressure difference at the two microphones caused by such a noise source.)

A separation value can be defined, as a measure of the difference between two sound pickup channels (e.g., two microphones) that are active during a phone call or during a recording session. The parameters of a Voice Activity Detector (VAD) or of a noise estimator, where the latter could be part of a noise suppressor, can be adjusted, based on the separation value. The separation value itself can be viewed as a good guess, or estimate, of the “local voice separation” which is the sound pressure level difference at the two microphones that can be attributed to the local voice only (as opposed to contributions from background or far away noise sources which may include competing talkers). As described in an earlier disclosure, such a process adjusts certain parameters of the VAD or the noise suppressor so as to rely less on the local voice separation, whenever a drop in the separation value is detected. This adjustment comes at the expense of erroneously interpreting “transient noises” as speech. However, voice distortion can result from the noise suppressor, if such adjustments are not made.

It has been further recognized that the separation value becomes smaller during non-optimal holding positions (the manner in which the near user is holding the mobile phone), and also during certain microphone occlusion conditions. An embodiment of the invention here aims to maintain the effectiveness (or accuracy) of a noise estimation process even during non-optimal holding positions of a phone, using sound pick up beam forming to maintain a sufficiently large separation value, in different holding positions. For each expected holding position, such as “up”, “down”, “normal”, “out”, etc., a specific acoustic pick up beam can be defined using the raw signals available from multiple microphones that may be treated by the beam forming process as a microphone array. For example, the microphones may be the bottom microphone and the top reference microphone that are built into a typical late model mobile phone handset, where the top reference microphone is the one that is acoustically open on the back or rear face of the handset. The beams can be tested in the laboratory to verify that they indeed result in a large enough separation value, relative to a noise reference input signal, in various holding positions. For example, the beams can be designed and tested to result in separation values that are sufficiently close to an “optimal” separation value that results during the corresponding holding position of a mobile phone, and in which a single, top reference microphone and a single bottom microphone are being used to produce the optimal separation value.

An embodiment of the invention aims to solve the problem of how to adaptively or dynamically, e.g., during in-the-field use of a mobile phone whose user is changing the holding position of the phone during a call or during a recorded meeting or interview session, choose one of several, simultaneously available, pre-determined acoustic pickup beams to be the first input of a two-channel noise suppression process. The first input may be considered a voice dominant input. The noise suppression process also has a second input, which may be considered a noise reference (or noise dominant) input. A separation value is computed for each beam, where the separation value is a measure of difference between i) strength of a respective one of the acoustic pickup beams and ii) strength of a noise reference input signal. The selected beam is the one whose computed separation value is the largest. The selected beam is applied to the first input of the two-channel noise suppression process, simultaneously with the noise reference input signal being applied to the second input. This should enable the noise suppression process to produce a more accurate noise estimate which in turn should lead to a less distorted, noise reduce voice input signal produced by the noise suppression process.

In order to improve the reliability or accuracy of the separation value for a given beam (which is expected to further improve the accuracy of the noise estimate computed by the noise suppression process), the difference calculation, or the measure of difference between i) strength of a given beam and ii) strength of the noise reference input signal, is performed after having spectrally shaped the noise reference input signal, the given beam, or both, so as to compensate for any frequency response variation between the far field responses exhibited by the given beam and by the noise reference input signal. In one embodiment, this is also described here as spectrally shaping the acoustic pickup response that is producing the noise reference input signal to “match” the one that is producing the given beam.

In one embodiment, the noise suppression process may have at its front end a two-channel noise estimator that uses the signals at the first and second inputs to produce an estimate of the noise (by itself), which then controls how the voice dominant signal at the first input is attenuated so as to produce a noise reduced voice input signal. In another embodiment, the noise suppression process has a VAD at its front end, that uses the signals at the first and second inputs to produce a binary, speech or non-speech, sequence that predicts whether each segment of the signal at the first input is speech or not.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment.

FIG. 1 is a block diagram of an audio system that produces a noise-reduced voice input signal, using a beam selector.

FIG. 2 is a block diagram of another embodiment of the audio system, in which a beam combiner is used.

FIG. 3 depicts a mobile phone hand set as an example of the audio system, overlaid with some example beams.

FIG. 4 is a block diagram of an example two-channel noise suppressor.

FIG. 5 is an example implementation of the audio system that has a programed processor.

### DETAILED DESCRIPTION

Several embodiments of the invention with reference to the appended drawings are now explained. Whenever aspects are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

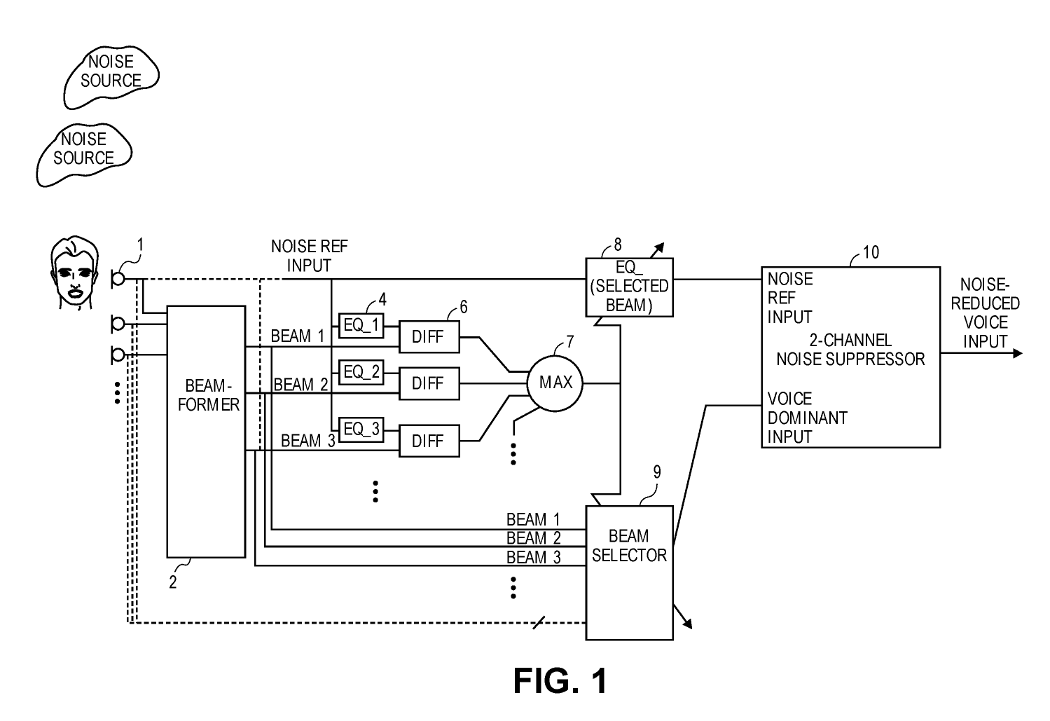

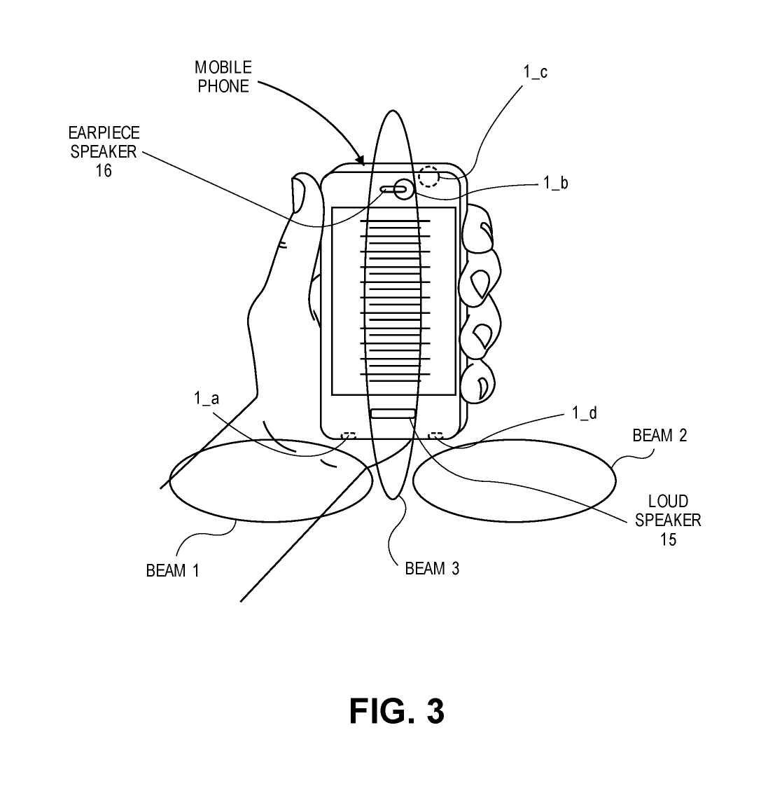

The process and apparatus described below are performed by an audio system whose user as depicted in FIG. 1 is also referred to as the local voice or primary talker, who in most cases is positioned closer to one side of a housing of the audio system containing the microphones 1. In the case of a mobile phone handset, an “optimal” holding position may be one where the local voice is closest to the bottom microphone 1_a (see FIG. 3). The ambient environment of the local voice contains far field noise sources, which may include any undesired source of sound that are considered to be in the far field of the sound pick up response of the audio system, where these far field noise sources may also include a competing talker. The block diagram in FIG. 1 is also used to describe a process for producing the inputs of a two-channel noise suppression process.

A number of microphones 1 (or individually, microphones 1_a, 1_b, 1_c, . . . ) may be integrated within the housing of the audio system, and may have a fixed geometrical relationship to each other. An example is depicted in FIG. 3 as a mobile phone handset having at least four microphones 1, namely two bottom microphones 1_a, 1_d and two top microphones 1_b, 1_c. The microphone 1_c may be referred to as a top reference microphone whose sound sensitive surface is open on the rear face of the handset, while the microphone 1_b has its sound sensitive surface open to the front and is located adjacent to an earpiece speaker 16. The handset also has a loudspeaker 15 located closer to the bottom microphone 1_a as shown. This is a typical arrangement for a current mobile phone handset; however it should be understood that other arrangements of microphones that may be viewed collectively as a microphone array whose geometrical relationship may be fixed and “known” at the time of manufacture are possible, e.g. arrangements of two or more microphones in the housing of a tablet computer, a laptop computer, or a desktop computer. Returning to FIG. 1, the signals from the microphones 1 are digitized, and made available simultaneously or parallel in time, to a beam former 2. The microphones 1 including their individual sensitivities and directivities may be known and considered when configuring the beam former 2, or defining each of the beams, such that the microphones 1 are treated as a microphone array. The beam former 2 may be a digital processor that can utilize any suitable combination of the microphone signals in order to produce a number of acoustic pick up beams. Glancing at FIG. 3 again, three example beams are depicted there, which may be produced using a combination of at least two microphones, namely the bottom microphone 1_a and the top reference microphone 1_c. Beams of other shapes and/or using other combinations of the microphones 1 (including ones that are not shown) are possible and may be suitable for a particular type of audio system, as a function of the shape of the housing, the geometrical relationship between the microphones 1, the sensitivities and directivities of the microphones 1, and the expected holding positions of the audio system by the user (e.g., handset mode vs. speaker phone mode). In the particular example of a mobile phone, the shape of the beams may be designed based on the expected positions in which the mobile phone handset will be held in one hand, during its use by the end user. Such holding positions include “normal” (against the ear), “up” (away from the ear with the error microphone 1_b facing the user), “out” (away from the ear with the reference microphone 1_c facing the user), and “down” (where the handset is being held essentially horizontally such that the reference microphone 1_c is facing downward and farther away from the user than the bottom microphone 1_a). The beams that have been defined for these various positions (e.g., one or more beams for each holding position) can be tested in the laboratory to verify that they result in a large enough separation value (while the phone is being used in the various holding positions).

The parameter referred to here as separation value is a measure of the difference between the strength of a primary sound pick up channel, and the strength of a secondary sound pick up channel, where the local voice (primary talker's voice) is expected to be more strongly picked up by the primary channel than the secondary channel. The secondary channel here is the one to which a noise reference input signal is applied. An embodiment of the invention here aims to correctly select one of several beams that are simultaneously available, for example during a phone call or during a meeting or recording session, as being the primary pickup channel or the voice dominant input, of a two-channel noise suppressor 10. The separation value may be computed in the spectral domain, for each digital audio time frame. There may be a separation vector defined, that has a number of separation values that are associated with a corresponding number of frequency bins. Alternatively, the separation value may be a statistical measure of the central tendency, e.g. average, of the difference (subtraction or ratio) between the primary and secondary input audio channels, as an aggregate of all audio frequency bins, or alternatively across a limited band in which the local voice is expected (e.g. 400 Hz to 1 kHz), or a limited number of frequency bins, of the spectral representation of each frame. A sequence of such vectors or separation values are continually computed, each being a function of a respective time frame of the digital audio. While an audio signal can be digitized or sampled into frames that are each for example between 5-50 milliseconds long, there may be some time overlap between consecutive frames.

In one embodiment, the strengths of the primary and secondary channels are computed as power spectra in the spectral or frequency domain, or they may be computed as energy spectra. This may be based on having first transformed the primary and secondary sound pick up channels on a frame by frame basis into the frequency domain (also referred to as spectral domain.) Alternatively, the strengths of the primary and secondary sound pick up channels may be computed directly in the discrete time domain, on a frame by frame basis. An example separation value may be as follows:

$$Separation value = 1 / N {\sum }_{i = 1}^{N} ( 10 log PSpri ( i ) - 10 log PSsec ( i ) )$$

Here, N is the number of frequency bins in the frequency domain representation of the digital audio frame, PSpri and PSsec are the power spectra of the primary and secondary channels, respectively, and i is the frequency index. This is an example where the strength of a signal is an average (over N frequency bins) power. Other ways of defining the separation value, based on a difference computation, are possible, where the term “difference” is understood to refer to not just a subtraction as shown in the example formula above of logarithmic values, but also a ratio calculation as well. A differencing unit 6 as depicted in FIG. 1 is provided to compute the separation value.

Studies show that the separation value may be high when the talker's voice is more prominently reflected in the primary channel than in the secondary channel, e.g. by about 14 dB or higher. The separation value drops when the mobile phone handset is no longer being held in its optimal or normal position, for example dropping to about 10 dB and even further in a high ambient noise environment to no more than 5 dB.

Still referring to FIG. 1, the separation value is computed in each differencing unit 6 (in this case there are three such units shown, corresponding to the three available beams, although of course additional differencing units will be provided if there are additional beams available.) Each differencing unit 6 has a primary sound pickup channel input that is to receive its respective or associated beam signal, and a secondary sound pickup channel to which is applied the same noise reference input signal, as shown. Each beam is thus compared to the same noise reference input signal. In one embodiment, the noise reference input signal is fixed to be a single microphone signal, for example that of the bottom microphone 1_a (see FIG. 3). Alternatively, a selection process may be envisaged that selects one of the available beams (being produced by the beam former 2), to be the noise reference input signal. As another alternative, the noise reference input signal may be computed as a combination (e.g. weighted sum) of two or more microphone signals from two or more of the microphones 1, respectively. The audio system may show better performance if the dynamic or adaptation process changes the selection of the beam for the voice dominant input (of the noise suppressor 10), rather than dynamically changing the selection of the noise reference input signal. Maintaining the noise reference input signal fixed while dynamically changing the voice beam (or the voice dominant input signal) could also strike a favorable balance between complexity and power consumption, since fixing the noise reference input signal while adaptively selecting only the beam for the voice dominant input may help lower the power consumption of the audio system (as compared to also dynamically changing the selection of the noise reference input signal.)

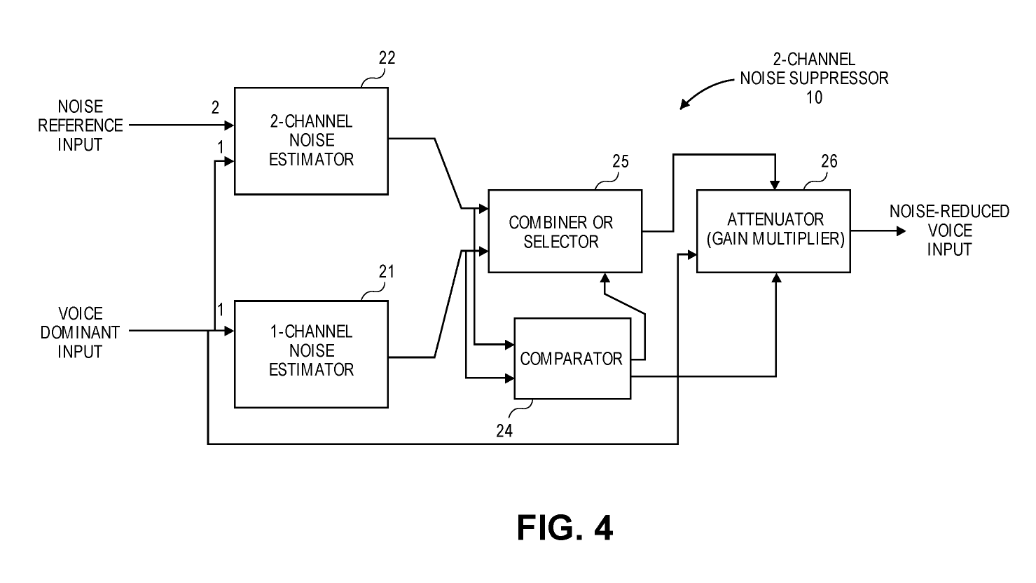

The audio system in FIG. 1 also has a maximum detector 7, which serves to compare the separation values that are provided by the differencing units 6 to each other, in order to identify the largest, and then indicate this finding to a beam selector 9. For example, the maximum detector 7 may find that the separation value produced by the differencing unit 6 that is associated with beam 3 is the largest of the three available, in this example, such that the beam selector 9 in this case acting as a multiplexor in response forwards only beam 3 to the voice dominant input (of the two-channel noise suppressor 10.) This selection and application of a beam to the voice dominant input of the noise suppressor 10 occurs dynamically and changes adaptively during use of the audio system, as a function of, for example, the changing holding position (e.g., the way a mobile phone is being held by its end user.) At the same time, the noise reference input signal is applied to the noise reference input of the two-channel noise suppressor 10, thereby enabling the noise suppressor 10 to produce a noise reduced voice input signal. An example of the noise suppressor 10 is given below in connection with FIG. 4, although any suitable two-channel noise suppressor may be used. In one embodiment, each of the beams has been predetermined before the above-described process begins, and these beams remain fixed during the process of adaptively changing the selection of the beam that is forwarded to the voice dominant input.

To improve accuracy of a noise estimation process that may be part of the two-channel noise suppressor 10 (further described below), the effective comparison between each of the beams and the noise reference input (by the maximum detector 7) needs to take into consideration a fact that the far field response contained in a given beam (to the same far field noise source) may have a different frequency response relative to the response of, for example, a single microphone that is producing the noise reference input signal. In other words, it is desirable, when comparing the effectiveness of one beam to another (using the scheme described in FIG. 1) to compensate for any frequency variation between the responses of the various beams, and that of a single microphone or multiple microphones that are producing the noise reference input signal (to the same far field noise source.) The far field noise source may be any transient noise source including a competing talker. For example, if the beam former 2 is a differential beam former, it may exhibit a high pass response in that its pick up at low frequencies is attenuated relative to high frequencies, for the same incident sound intensity, as compared to a single microphone. In other words, a beam that happens to pick up transient noises including competing talkers will have its low frequencies attenuated relative to its high frequencies, even though both low and high frequencies may have been emitted with the same power. This situation is addressed in the embodiment of FIG. 1 by the addition of the equalization (EQ) filters 4, 8, where the EQ filter 4 is to filter a beam signal while the EQ filter 8 is to filter the noise reference input signal. The EQ filters 4, 8 perform linear, spectral shaping or conditioning that is intended to match or “equalize” the response of the noise reference pick up with the far field response of a particular beam (in order to enable more accurate pick up of the same transient noises including competing talkers, by the various beams). In one embodiment, the compensation may be achieved by the EQ filter 8, where the noise reference input signal is spectrally shaped by the EQ filter 8 to reduce gain in a low frequency band by an amount that is commensurate with how much the far field response of the selected beam is expected to be attenuated in the low frequency band (relative to a high frequency band.)

The transfer function of the EQ filter 8 may be the same as that of the EQ filter 4 that is associated with the selected beam. In other words, if the maximum detector 7 indicates that beam 3 has the largest separation value, then the EQ filter 8 is configured to have the transfer function the EQ filter 4 (EQ_3). As explained above, when the beams are defined in the laboratory, the transfer functions of their associated EQ filters 4 may also be defined in the laboratory, and may be fixed prior to the noise suppression process operating during in-the-field use of the audio system. Thus, in one embodiment, the EQ filter 8 is dynamically configured or changed during in-the-field use, in accordance with the changing beam selection indicated by the maximum detector 7, so that the noise reference input being applied to the two-channel noise processor 10 is spectrally shaped in accordance with the selected beam (in accordance with the fixed, EQ filter 4 of the selected beam.)

An alternative to the approach depicted in FIG. 1 of spectrally shaping the noise reference input signal is to spectrally shape each of the acoustic pick up beams, so as to compensate for the same variations in their far-field frequency responses mentioned above. In that case, the noise reference input signal is applied directly to the two-channel noise suppressor 10 without passing through the EQ filter 8, while the comparison made by the maximum detector 7 is based on the separation values that have been computed (by the differencing units 6) for filtered versions of the beams. In other words, the EQ filter 4 is now in line with its respective beam signal so that the beam signal is EQ filtered prior to being applied to the input of its respective differencing unit 6. The EQ filters 4 in such an embodiment may for example raise the gain in a low frequency band relative to a high frequency band, consistent with the expected far field response of the beam being attenuated in the low frequency band. Note also that in such an embodiment, the selected beam should be filtered, after being selected by the beam selector 9, prior to being received at the voice dominant input of the two-channel noise suppressor 10, in accordance with an EQ filter whose transfer function has been configured to be the same as that of the EQ filter 4 used for filtering the selected beam. Said another way, one difference between this embodiment and the one depicted in FIG. 1 is that the measure of difference computed by each differencing unit 6 is between the spectrally shaped respective beam and the (unequalized) noise reference input signal; another difference is that the selected beam is spectrally shaped prior to being received at the voice dominant input of the noise suppressor 10.

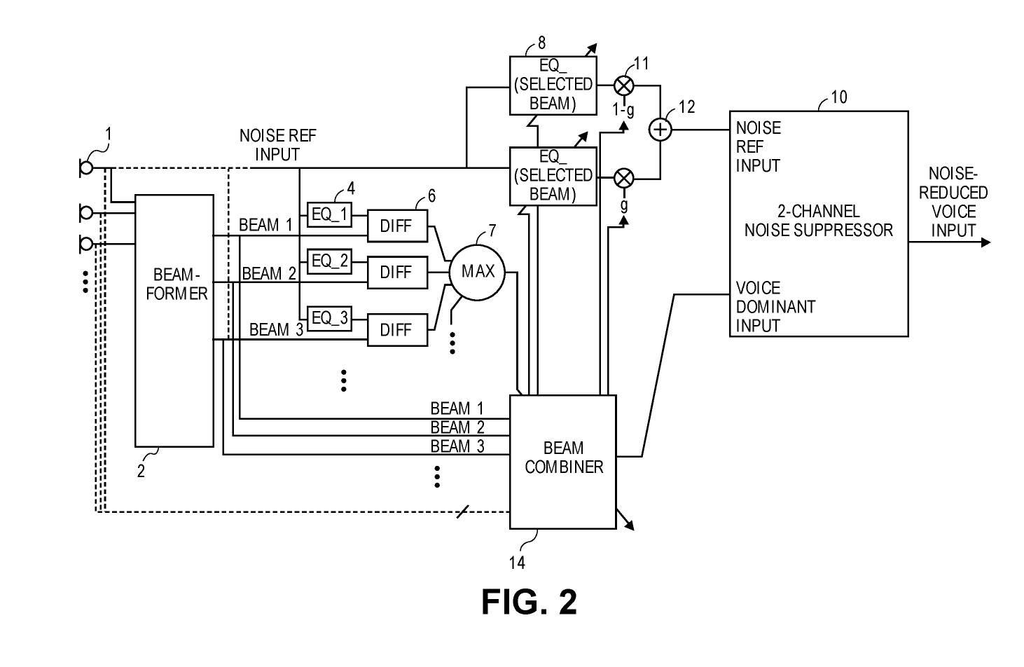

Turning now to FIG. 2, this is a block diagram of another embodiment of the audio system, where in this case instead of the beam selector 9, a beam combiner 14 is used to produce the voice dominant input of the two-channel noise suppressor 10. The system may otherwise operate similar to the system in FIG. 1 at least in so far as the beam former 2 and the computation of the separation values by the differencing units 6 are concerned, with the following additional features. First, the maximum detector 7 in this embodiment provides an indication of not just the largest separation value (or beam) but also the next largest. This embodiment may be useful when there are three or more beams available. The top, two separation values (of two of the beams) are indicated, by the maximum detector 7. More generally however, depending on the number of available beams, this embodiment may also encompass selecting more than two of the largest separation values, corresponding to more than two selected beams. Also, in this embodiment, a beam combiner 14 combines the two or more selected beams to produce a single, combined beam signal that is then applied to the voice dominant input. This combination may be a simple weighted sum, where the weightings are selected based on, for example, the relative difference between the separation values of the two or more beams. For example, if the largest beam is 20% larger than the next largest, then it may be weighted 20% more. This weighting is also reflected as scalar gains, g<1 and 1−g (for the example in FIG. 2 of only two selected beams) which are applied to respective instances (copies) of the noise reference input signal, through a multiplier 11, before the weighted noise reference input signals are combined into a single combined noise reference input signal, by a summing unit 12. Thus, in this embodiment, the noise reference input signal is duplicated and filtered in accordance with the transfer functions of the EQ filters 4 that are assigned to the top two selected beams (reflected as EQ filters 8 in two instances, as shown) before being combined and received at the noise reference input. Note that since the processing performed by the EQ filters 8 and by the multiplier 11 are linear operations, their order can be different (prior to these spectrally shaped and gain adjusted or weighted noise reference input signals being summed by the summing unit 12). Operation in FIG. 2 may otherwise be similar to the embodiment of FIG. 1, including computing the strengths of the acoustic pick up beams and the strength of the noise reference input signal within the differencing unit 6 as for example a statistical central tendency (e.g. average) of the energy or power of the signal over a predefined frequency band, in a given digital audio frame.

Given the linearity of the spectral shaping process performed by the EQ filters 4, 8, the same alternative that was described above in connection with FIG. 1 is also applicable to FIG. 2. Instead of spectrally shaping the noise reference input signal by the EQ filter 4 at the input of each differencing unit 6 (FIG. 1), the EQ filter 4 is instead applied to the beam (before input to the differencing unit 6). For example, the EQ filter 4 in that case would raise the gain in the low frequency band for each associated beam, so as to equalize the far filed frequency response with that of, for example, a single or multiple ones of the microphones 1 that are producing the noise reference input signal. In that case, the EQ filters 8, the multipliers 11, and summing unit 12 are removed from the noise reference input path, and instead the EQ filters 8 may be incorporated into the combiner 14 where they are applied to the selected beams (noting of course that the transfer function in this case for each EQ filter 8 may be the same its counterpart EQ filter 4, of the top two selected beams. Thus, instead of spectrally shaping the noise reference input signal as shown in FIG. 2, the alternative solution is to spectrally shape each of the beams (to compensate for variations in their far field frequency responses); also, the measure of difference computed by the differencing unit 6 is now between the spectrally shaped respective beam and the un-equalized noise reference input signal. Also for this embodiment, the beam combiner 14 is modified so that when combining the selected beams, each of the selected beams is spectrally shaped to compensate for variation in its far field frequency response, in addition to being weighted by the g and 1−g factors (resulting in the combined beam signal that is provided to the voice dominant input).

In one embodiment of the invention, the choice of beam that is made ultimately by the beam selector 9 (FIG. 1) or by the maximum detector 7 in the embodiment of FIG. 2 that may be based purely on the separation values, by the differencing unit 6 and by the maximum detector 7, when using a particular class of noise suppressor, namely the two-channel noise suppressor 10 (an example of which will be given below in connection with FIG. 4). An alternative however when selecting beams is to also give some consideration to one or more of the raw microphone signal as well (depicted by the dotted lines directed into the beam selector 9 in FIG. 1.)

In the embodiment of FIG. 2, the combining of the “best” two beams may be in the same proportion as their respective separation values (where some value for g<1 is defined). In such an embodiment, the maximum contribution of any beam (to the combined signal at the output of the beam combiner 14) can be restricted, which results in restricting the adjustment that is available with multiple beams (for a given holding position of the audio system). This process may improve the robustness of the beam combiner 14. For example, in the situation where there are two beams that are to be selected, to be combined (e.g. the beams having the top two largest separation values), the beam combiner 14 can be configured so that regardless of the separation values, no single beam can contribute more than 70% (g≦0.7).

FIG. 4 is a block diagram of an example of the two-channel noise suppressor 10. A pair of noise estimators 21, 22 operate in parallel to generate their respective noise estimates, by processing the two audio signals, the noise reference input and the voice dominant input as shown. The 2-channel noise estimator relies on both of the input audio signals as shown, while the 1-channel noise estimator 21 relies on just the voice dominant input (to computed its output noise estimate.) The 2-channel noise estimator 22 may be more aggressive than the 1-channel estimator 21 in that it is more likely to generate a greater noise estimate, during for example a phone call or a meeting recording session in which both local voice and background acoustic noise have been picked up. When background noise is mostly stationary noise, such as car noise, the two estimators 21, 22 should provide for the most part similar estimates, except that in some instances there may be more spectral detail provided by the 2-channel estimator 22 which may be due to a better VAD being used as described further below, and the ability to estimate noise even during speech activity. On the other hand, when there are significant transients in the background, such as babble and road noise or competing talkers, the 2-channel estimator 22 can be more aggressive, since transients are estimated more accurately in that case. The 1-channel estimator 21 can erroneously interpret such transients as speech, thereby excluding them from its noise estimate. In contrast, the 2-channel estimator can erroneously interpret some speech as noise, if there is not enough of a difference in power between the two inputs to it.

The noise estimators 21, 22 operate in parallel, where the term “parallel” here means that the sampling intervals or frames over which the audio signals are processed have to, for the most part, overlap in terms of absolute time. In one embodiment, the noise estimate produced by each estimator 21, 22 is a respective noise estimate vector, where this vector has several spectral noise estimate components, each being a value associated with a different audio frequency bin. This is based on a frequency domain representation of the discrete time audio signal, within a given time interval or frame. A spectral component or value within a noise estimate vector may refer to magnitude, energy, power, energy spectral density, or power spectral density, in a single frequency bin.

A combiner-selector 25 receives the two noise estimates and in response generates a single output noise estimate, based on a comparison, provided by a comparator 24, between the two noise estimates. The comparator 24 allows the combiner-selector 25 to properly estimate noise transients using the output from the 2-channel estimator 22. In one instance, the combiner-selector 25 combines, for example as a linear combination or weighted sum, its two input noise estimates to generate its output noise estimate. However, in other instances, the combiner-selector 25 may select as its output the input noise estimate from the 1-channel estimator 21, and not the one from the 2-channel estimator 22, and vice-versa. Each of the estimators 21, 22, and therefore the combiner-selector 25, may update its respective noise estimate vector in every frame, based on the audio data in every frame, and on a per frequency bin basis. The output of the combiner or selector 25 can thus change (dynamically or adaptively) during the phone call or during the meeting or interview recording session.

The output noise estimate from the combiner-selector 25 is used by an attenuator (gain multiplier) 26, to control how to attenuate the voice dominant input signal in order to reduce the noise components therein. The action of the attenuator 26 may be in accordance with a conventional gain versus SNR curve, where typically the attenuation is greater when the noise estimate is greater. The attenuation may be applied in the frequency domain, on a per frequency bin basis, and in accordance with a per frequency bin noise estimate which is provided by the combiner-selector 25. The decisions by the attenuator 26 may also be informed with information provided by the comparator 24 on for example the relative strengths of the two noise estimates that are provided to the combiner or selector 25.

In one embodiment, the output noise estimate of the combiner-selector 25 is a combination of the first and second noise estimates, or is a selection between one of them, that favors the more aggressive, 2-channel estimator 22. But this behavior stops when the 2-channel noise estimate (produced by the estimator 22) becomes greater than the 1-channel noise estimate (produced by the estimator 21) by a predetermined threshold or bound (configured into the comparator 24), in which case the contribution of the 2-channel noise estimate is lessened or it is no longer selected. In one example, the output noise estimate from the combiner-selector 25 is the 2-channel noise estimate except when the 2-channel noise estimate is greater than the 1-channel noise estimate by more than a predetermined threshold in which case the output noise estimate becomes the 1-channel noise estimate. This limit on the use of the 2-channel noise estimate helps avoid the application of too much attenuation by the noise suppressor 10, in situations similar to when the user of a mobile phone, while in a quiet room or in a car, is close to a window or a wall, which may then cause reflections of the user's voice to be erroneously interpreted as noise by the more aggressive estimator. Another similar situation is when the user audio device is being held in an orientation that causes the voice to be erroneously interpreted as noise.

Still referring to FIG. 4, the 1-channel noise estimator 21 processes the first input signal (1) to compute a first ambient noise estimate, while the 2-channel noise estimator 22 processes both the first and second input signals (1), (2), to compute a second ambient noise estimate. The first and second ambient noise estimates are compared with a threshold, by the comparator 24. The second ambient noise estimate is selected as controlling an attenuation that is applied to the first input signal (by the attenuator 26) to produce a noise reduced voice signal of the noise suppression process, but not when the second ambient noise estimate is greater than the first ambient noise estimate by more then the threshold in which case the first ambient noise estimate is selected to control the attenuation that is applied to the first input signal to produce the noise reduced voice signal.

Although not shown in the drawings, another embodiment of the invention provides the selected beam (FIG. 1) or the combined beam signal (FIG. 2) as a voice dominant input of a 2-channel voice activity detector (VAD), while the noise reference signal is provided to a noise dominant input of the VAD. In one embodiment, such a VAD is implemented by first computing

ΔX(k)=|X₁(k)|−|X₂(k)|

where X1(k) is the spectral domain version of the magnitude, energy or power of the voice dominant input signal, and X2(k) is that of the noise reference input signal. In other words, the term DeltaX(k) in the equation above is the difference in spectral component k of the magnitudes, or in some cases the powers or energies, of the two input signals. Next, a binary VAD output decision (Speech or Non-speech) for spectral component k is produced as the result of a comparison between DeltaX(k) and a threshold: if DeltaX(k) is greater than the threshold, the decision for bin k is Speech, but if the DeltaX(k) is less than the threshold, the decision is Non-speech. The binary VAD output decision may be used by any available speech processing algorithms including for example automatic speech recognition engines.

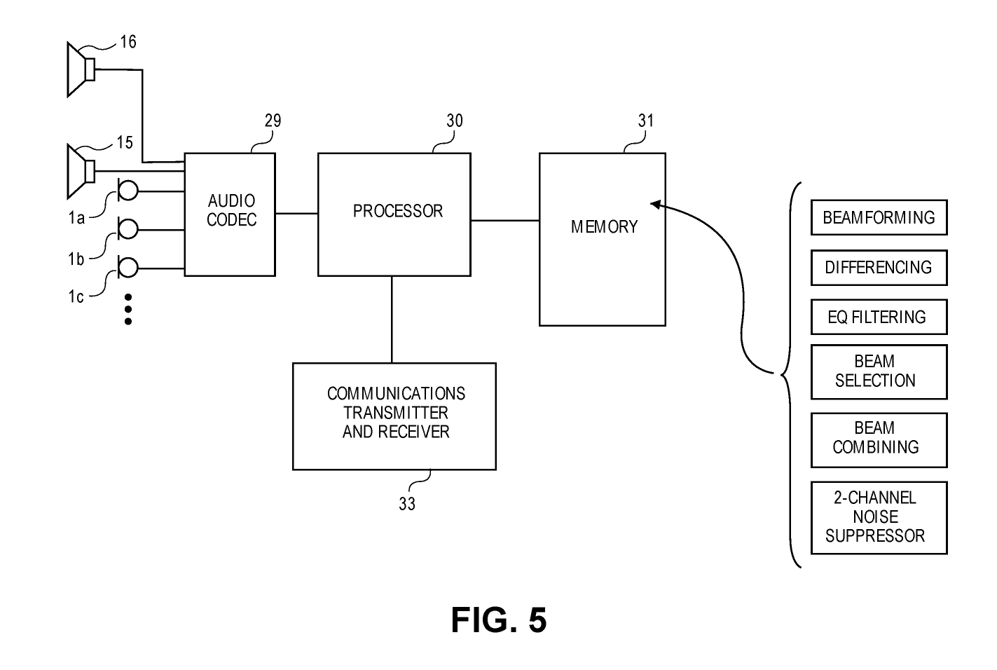

Turning now to FIG. 5, this is an example implementation of the audio systems described above in connection with FIG. 1 or FIG. 2, that has a programed processor 30. The components shown may be integrated within a housing such as that of a mobile phone (e.g., see FIG. 3.) These include a number microphones 1 (1a, 1b, 1c, . . . ) which may have a fixed geometrical relationship to each other and whose operating characteristics can be considered when configuring the processor 30 to act as the beam former 2 (see above) when the processor 30 accesses the microphone signals produced by the microphones 1, respectively. The microphone signals may be provided to the processor 30 and/or to a memory 31 (e.g., solid state non-volatile memory) for storage, in digital, discrete time format, by an audio codec 29. The processer 30 may also provide the noise reduced voice input signal produced by the noise suppression process, to a communications transmitter and receiver 33, e.g., as an uplink communications signal of an ongoing phone call.

The memory 31 has stored therein instructions that when executed by the processor 30 produce the acoustic pickup beams using the microphone signals, compute separation values (as described above), select one of the acoustic pickup beams (as described above in connection with FIG. 1), apply the selected beam to a first input of a two channel noise suppression process, and apply the noise reference input signal to a second input of the two-channel noise suppress (as described above). The instructions that program the processor 30 to perform all of the processes described above, or to implement the beam former 2, differencing units 6, EQ filters 4, 8, beam selector 9, beam combiner 14, and the 2-channel noise suppressor 10, are all referenced in FIG. 5 as being stored in the memory 31 (labeled by their descriptive names, respectively.) These instructions may alternatively be those that program the processor 30 to perform the processes, or implement the components described above in connection with the embodiment of FIG. 2. Note that some of these circuit components, and their associated digital signal processes, may be alternatively implemented by hardwired logic circuits (e.g., dedicated digital filter blocks, hardwired state machines.)

While certain embodiments have been described and shown in the accompanying drawings, it is to be understood that such embodiments are merely illustrative of and not restrictive on the broad invention, and the invention is not limited to the specific constructions and arrangements shown and described, since various other modifications may occur to those of ordinary skill in the art. The description is thus to be regarded as illustrative instead of limiting.

1. A process for producing the first and second inputs of a two input channel noise suppression process using a plurality of acoustic pickup beams, comprising:
computing a plurality of separation values, each being a measure of difference between i) strength of a respective one of a plurality of acoustic pickup beams, that have been produced by a beamforming process using a plurality of microphone signals, and ii) strength of a noise reference input signal;
selecting one of the plurality of acoustic pickup beams, wherein the selected beam is the one whose computed separation value is the largest of the plurality of separation values;
applying the selected beam to a first input of a two channel noise suppression process; and
applying the noise reference input signal to a second input of the two-channel noise suppression process.

2. The process of claim 1 wherein computing the plurality of separation values comprises:
spectrally shaping the noise reference input signal to compensate for variation in frequency response of the respective one of the acoustic pickup beams, wherein the measure of difference is between the respective one of the acoustic pickup beams and the spectrally shaped noise reference input signal,
and wherein applying the noise reference input signal to the second input of the two-channel noise suppression process comprises spectrally shaping the noise reference input signal in accordance with the selected beam.

3. The process of claim 1 wherein computing the plurality of separation values comprises:
spectrally shaping each of the plurality of acoustic pickup beams to compensate for variations in their frequency responses, wherein the measure of difference is between the spectrally shaped respective one of the acoustic pickup beams and the noise reference input signal,
and wherein applying the selected beam to the first input of the two channel noise suppression process comprises spectrally shaping the selected beam to compensate for variation in its frequency response.

4. The process of claim 1 wherein selecting one of the plurality of acoustic pick up beams comprises analyzing the plurality of microphone signals.

5. The process of claim 1 further comprising selecting one of the plurality of acoustic pick up beams to be the noise reference input signal.

6. The process of claim 1 further comprising selecting one of the plurality of microphone signals to be the noise reference input signal.

7. The process of claim 1 further comprising the 2-channel noise suppression process, as follows:
processing the first input signal using a single-channel noise estimator, to compute a first ambient noise estimate;
processing the first and second input signals using a two-channel noise estimator, to compute a second ambient noise estimate;
comparing the first and second ambient noise estimates with a threshold; and
selecting the second ambient noise estimate as controlling an attenuation that is applied to the first input signal to produce a noise reduced voice signal of the noise suppression process, but not when the second ambient noise estimate is greater than the first ambient noise estimate by more then the threshold in which case the first ambient noise estimate is selected to control the attenuation that is applied to the first input signal to produce the noise reduced voice signal.

8. A process for producing a first input of a two input channel noise suppression process using a plurality of acoustic pickup beams, the process comprising:
computing a plurality of separation values, each being a measure of difference between i) strength of a respective one of a plurality of acoustic pickup beams, that have been produced by a beamforming process that uses a plurality of input microphone signals, and ii) strength of a noise reference input signal;
selecting at least two of the plurality of acoustic pickup beams, wherein the selected beams are those whose computed separation values are the largest and the next largest, of the plurality of separation values;
combining the selected beams to produce a combined signal;
applying the combined signal to a first input of a two channel noise suppression process; and
applying the noise reference input signal to a second input of the two-channel noise suppression process.

9. The process of claim 8 wherein the strength is a computed statistical central tendency of the energy or power of a signal, being the acoustic pickup beam or the noise reference input signal, over a predefined frequency band, in a given digital audio frame.

10. The process of claim 8 wherein computing the plurality of separation values comprises:
spectrally shaping the noise reference input signal to compensate for variation in frequency response of a respective one of the acoustic pickup beams, wherein the measure of difference is between the respective one of the acoustic pickup beams and the spectrally shaped noise reference input signal,
and wherein applying the noise reference input signal to the second input of the two-channel noise suppression process comprises spectrally shaping at least two instances of the noise reference input signal in accordance with the selected beams.

11. The process of claim 8 wherein computing the plurality of separation values comprises:
spectrally shaping each of the plurality of acoustic pickup beams to compensate for variations in their frequency responses, wherein the measure of difference is between the spectrally shaped respective one of the acoustic pickup beams and the noise reference input signal,
and wherein combining the selected beams comprises spectrally shaping each of the selected beams to compensate for variation in its frequency response.

12. The process of claim 8 further comprising the two-channel noise suppression process, as follows:
processing the first input signal using a single-channel noise estimator, to compute a first ambient noise estimate;
processing the first and second input signals using a two-channel noise estimator, to compute a second ambient noise estimate;
comparing the first and second ambient noise estimates with a threshold; and
selecting the second ambient noise estimate as controlling an attenuation that is applied to the first input signal to produce a noise reduced voice signal of the noise suppression process, but not when the second ambient noise estimate is greater than the first ambient noise estimate by more then the threshold in which case the first ambient noise estimate is selected to control the attenuation that is applied to the first input signal to produce the noise reduced voice signal.

13. The process of claim 8 further comprising selecting one of the plurality of acoustic pick up beams to be the noise reference input signal.

14. The process of claim 8 further comprising selecting one of the plurality of microphone signals to be the noise reference input signal.

15. An audio system to produce a noise-reduced voice input signal, comprising:
a housing having integrated therein a plurality of microphones having a fixed geometrical relationship to each other;
a processor to access a plurality of microphone signals produced by the plurality of microphones, respectively; and
memory having stored therein instructions that when executed by the processor produce a plurality of acoustic pickup beams using the plurality of microphone signals, compute a plurality of separation values each being a measure of difference between i) strength of a respective one of the plurality of acoustic pickup beams and ii) strength of a noise reference input signal, select one of the plurality of acoustic pickup beams, wherein the selected beam is the one whose computed separation value is the largest of the plurality of separation values, apply the selected beam to a first input of a two channel noise suppression process, and applying the noise reference input signal to a second input of the two-channel noise suppression process.

16. The system of claim 15 wherein the memory has stored therein instructions that, when executed by the processor, compute the plurality of separation values by
spectrally shaping the noise reference input signal to compensate for variation in frequency response of the respective one of the acoustic pickup beams, wherein the measure of difference is between the respective one of the acoustic pickup beams and the spectrally shaped noise reference input signal,
and wherein the noise reference input signal is applied to the second input of the two-channel noise suppression process by spectrally shaping the noise reference input signal in accordance with the selected beam.

17. The system of claim 15 wherein the memory has stored therein instructions that, when executed by the processor, compute the plurality of separation values by
spectrally shaping each of the plurality of acoustic pickup beams to compensate for variations in their frequency responses, wherein the measure of difference is between the spectrally shaped respective one of the acoustic pickup beams and the noise reference input signal,
and wherein the selected beam is applied to the first input of the two channel noise suppression process by spectrally shaping the selected beam to compensate for variation in its frequency response.

18. An audio system to produce a noise-reduced voice input signal, comprising:
a housing having integrated therein a plurality of microphones having a fixed geometrical relationship to each other;
a processor to access a plurality of microphone signals produced by the plurality of microphones, respectively; and
memory having stored therein instructions that when executed by the processor produce a plurality of acoustic pickup beams using the plurality of microphone signals, compute a plurality of separation values each being a measure of difference between i) strength of a respective one of the plurality of acoustic pickup beams and ii) strength of a noise reference input signal, select at least two of the plurality of acoustic pickup beams, wherein the selected beams are those whose computed separation values are the largest and the next largest, of the plurality of separation values, combine the selected beams to produce a combined signal, apply the combined signal to a first input of a two channel noise suppression process, and apply the noise reference input signal to a second input of the two-channel noise suppression process.

19. The system of claim 18 wherein the strength is a computed statistical central tendency of the energy or power of a signal, being the acoustic pickup beam or the noise reference input signal, over a predefined frequency band, in a given digital audio frame.

20. The system of claim 18 wherein the memory has stored therein instructions that, when executed by the processor, compute the plurality of separation values by spectrally shaping the noise reference input signal to compensate for the variation between the far field and the near field frequency responses of the respective one of the acoustic pickup beams, wherein the measure of difference is between the respective one of the acoustic pickup beams and the spectrally shaped noise reference input signal,
and wherein the noise reference input signal is applied to the second input of the two-channel noise suppression process by spectrally shaping the noise reference input signal in accordance with the variation of the selected beam.

21. The system of claim 18 wherein the memory has stored therein instructions that, when executed by the processor, compute the plurality of separation values by spectrally shaping each of the plurality of acoustic pickup beams to compensate for variation between their far field and near field frequency responses, wherein the measure of difference is between the spectrally shaped respective one of the acoustic pickup beams and the noise reference input signal,
and wherein the selected beam is applied to the first input of the two channel noise suppression process by spectrally shaping the selected beam to compensate for the variation the in its frequency response.
